(19) United States
(12) Patent Application Publication
(10) Pub. No.: US 2008/0318493 A1
(43) Pub. Date: Dec. 25, 2008

(54) Method of Manufacturing Polishing Carrier and Silicon Substrate for Magnetic Recording Medium, and Silicon Substrate for Magnetic Recording Medium

(75) Inventor: Katsuaki Aida, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., TOYKO (JP)

(21) Appl. No.: 11/658,802

(22) PCT Filed: Aug. 1, 2005
(86) PCT No.: PCT/JP2005/014477

§ 371 Date: Jan. 30, 2007

Related U.S. Application Data
(60) Provisional application No. 60/600,778, filed on Aug. 12, 2004.

(30) Foreign Application Priority Data
Aug. 2, 2004 (JP) 2004-225660

(51) Int. Cl. B24B 1/00; G11B 5/62; B24B 37/04

(52) U.S. Cl. 451/36; 423/324; 451/550

(57) ABSTRACT

An object is to provide a polishing carrier that can prevent scratches from occurring on the edge face of a substrate, and prevent debris from being produced from the edge face, while a single crystal silicon substrate, which is fragile, and has a high cleavage strength, is polished, and to make it difficult for debris to be produced due to rubbing against a cassette when it is stored in a cassette in subsequent processing, and prevent the substrate from being broken. Therefore a part of the internal circumference of a substrate holding hole in a polishing carrier, that makes contact with the silicon substrate is formed from a cushion whose hardness is less than that of the silicon substrate. For the cushion, any type selected from for example suede, polyamide resin, polypropylene resin, or epoxy resin may be used. Especially, the use of epoxy resin is desirable.

Priority is claimed on Japanese Patent Application No. 2004-225660, filed Aug. 2, 2004, and U.S. Provisional application No. 60/600,778, filed Aug. 12, 2004, the content of which are incorporated herein by reference.

### TECHNICAL FIELD

The present invention relates to a method of polishing a silicon substrate for a magnetic recording medium. In particular, it relates to the structure of a polishing carrier used when polishing a silicon substrate for a magnetic recording medium.

### BACKGROUND ART

As the range of information equipment has expanded in recent years, the memory capacity of magnetic recording media has continued to increase. Especially, magnetic discs which play a major role as the external memory of computers, increase their memory capacity and memory density year by year. However, development is required in order to perform higher density recording. For example, due to the development of notebook type personal computers and palm top personal computers, a small sized and impact resistant recorder is desirable. Therefore a magnetic recording medium that enables higher density recording and has great mechanical strength is desirable. Furthermore, in recent years; subminiature magnetic recording media have been used for some navigation systems and portable music reproducing units.

Heretofore, aluminum alloy, substrates plated with NiP, or glass substrates, have been used as substrates for magnetic discs, serving as magnetic recording media. However, aluminum alloy substrates have poor wear resistance and workability, so NiP plating is applied in order to compensate for these drawbacks. However, those on which a NiP plating is applied have drawbacks in that they can bend easily, they can become magnetized, and so forth. Furthermore, glass substrates have a problem in that a layer of stress occurs on the surface at the time of tempering, and compressive stress acts on it. Hence they can bend easily when the substrate is heated.

In the case of a subminiature magnetic recording medium of 1 inch (25.4 mmØ) or 0.85 inch (21.6 mmØ) in diameter, capable of recording at high density, bending of a substrate is a catastrophic defect. For a substrate of a subminiature magnetic recording medium, a material is desirable that is thinner and resistant against impact, difficult to be deformed by external force, that has a flat surface, and on which a magnetic recording layer can be formed easily.

Therefore, it is proposed to use a silicon substrate, which is used frequently as a semiconductor device substrate, as a magnetic recording medium (for example, refer to Japanese Unexamined Patent Application, First Publication No. 57-105826).

Single crystal silicon has a lot of merits, such as a lower density, a higher Young's modulus, a smaller thermal expansion coefficient, and better elevated temperature properties, than aluminum, and is electrically conductive. Therefore, it is desirable as a substrate material for a magnetic recording medium. The smaller the diameter of a substrate, the lower the impact force, and thus it is possible to make a durable magnetic recording device even if a silicon substrate is used.

Normally, a substrate to be used as a magnetic recording medium is finished to a mirror finish by lapping and polishing the disc-shaped substrate.

Lapping and polishing of the disc-shaped substrate are performed in a state in which substrates to be processed are placed in a plurality of circular substrate holding holes provided in a circular polishing carrier, and the substrates are held between the lower surface plate and the upper surface plate of a polishing device, by counter-rotation of the upper and lower surface plates. Here, a gear is formed in the outer peripheral part of the polishing carrier, and this gear is engaged with an internal gear and a sun gear. Accordingly, the polishing carrier performs a planetary motion due to the difference in the speed of rotation between the internal gear and the sun gear. As a result, the disc-shaped substrate is lapped and polished until its two surfaces reach a mirror finish at the same time.

For a polishing carrier as described above, a type is known in which a predetermined number of pre-pregs, obtained by saturating a glass woven fabric with epoxy resin and drying it, are laid on top of each other, and heated and pressed to form it into one piece. In the case where polishing is performed by using this polishing carrier, there is a possibility that scratch lines, so called speckled edge, occur due to the substrate being rubbed on the edge face of the substrate while in the polishing carrier, after it has been finished to a mirror finish in a mirror finish manufacturing process. In the case of a substrate with edge face speckling, there is a problem in that debris is produced by contact with a storage container used in subsequent processing, thus causing thermal asperities.

Therefore, in order to prevent scratches from being produced on the edge face (external peripheral side face) of a substrate during polishing or the like, it is proposed that the part of the internal edge of the substrate holding holes that hold the substrate, which makes contact with the substrate, is formed from a material whose hardness is less than or equal to 100 (Asker C) (for example, refer to Japanese Unexamined Patent Application, First Publication No. 2000-288922).

According to the proposal, a polishing carrier is disclosed that has substrate holding holes in which the part that makes contact with a glass substrate is formed from any of urethane, high pressure polyethylene, polycarbonate, vinyl chloride, and rubber, and there is no concern about scratches occurring on the edge face (outer peripheral side face) of the substrate during polishing or the like.

### DISCLOSURE OF INVENTION

However, since silicon substrates are more fragile than glass substrates, and have a high cleavage strength, it is difficult with a polishing carrier for glass substrates to prevent scratches from occurring on the edge face of the substrates during polishing.

The present invention aims to provide a structure of a polishing carrier that can prevent scratches from occurring on the edge face of a substrate, and prevent debris from being produced from the edge face, while a single crystal silicon substrate, which is fragile, and has a high cleavage strength, is polished, and to make it difficult for debris to be produced due to rubbing against a cassette when it is stored in a cassette in subsequent processing, and prevent the substrate from being broken.

In order to solve the above-described problems, the present application provides following inventions:

(1) a polishing carrier that has a substrate holding hole that holds a silicon substrate used for a magnetic recording medium, wherein a part of the internal circumference of the substrate holding hole that makes contact with the silicon substrate is formed from a cushion whose hardness is less than that of the silicon substrate;
(2) a polishing carrier according to (1), wherein epoxy resin is used as the cushion;
(3) a polishing carrier according to (1), wherein any type selected from suede, polyamide resin, and polypropylene resin is used as the cushion;
(4) a polishing carrier according to any one of (1) through (3), wherein in which a thickness of the cushion is less than or equal to 1 mm;
(5) a polishing carrier according to any one of (1) through (4), wherein a plurality of protrusions which make contact with the silicon substrate, are provided on the internal circumference surface of the cushion;
(6) a polishing carrier according to (5), wherein the number of the protrusions is between three and six;
(7) a method of manufacturing a silicon substrate for a magnetic recording medium, wherein a silicon substrate for a magnetic recording medium is polished using a polishing carrier according to any one of the first through the sixth aspect;
(8) a method of manufacturing a silicon substrate for a magnetic recording medium according to (7), wherein the silicon substrate for a magnetic recording medium media is polished by rotating the substrate by engagement with a sun gear and an internal gear; and
(9) a silicon substrate for a magnetic recording medium, which is manufactured using a method of manufacturing a silicon substrate for a magnetic recording medium according to (6) or (7).

If the part of the substrate holding hole, which makes contact with the silicon substrate, is formed into a cushion whose hardness is less than that of the silicon substrate, it is possible to effectively prevent scratches and the like occurring during polishing.

According to the present invention, even when polishing a single crystal silicon substrate that is fragile, and has a high cleavage strength, it is possible to effectively prevent scratches and the like from occurring, thus reducing the occurrence of defective product. Therefore, it is a significant contribution to the spread of subminiature magnetic recording media.

### BRIEF DESCRIPTION OF THE DRAWINGS

FIG. 1 is a plan view of a polishing carrier according to a first embodiment.

FIG. 2 is a diagram showing a cross-section along a line A-A′ of FIG. 1.

FIG. 3 is a diagram showing a state in which a polishing carrier is mounted in a polishing device.

FIG. 4 is a diagram to explain the conditions in which a substrate is polished.

FIG. 5 is a plan view of a polishing carrier according to a second embodiment.

FIG. 6 is a diagram showing a cross-section along a line B-B′ of FIG. 5.

FIG. 7 is a cross-sectional diagram of a polishing carrier according to a third embodiment.

FIG. 8 is a cross-sectional diagram of a polishing carrier according to a fourth embodiment.

FIG. 9 is a cross-sectional diagram of a polishing carrier according to a fifth embodiment.

FIG. 10 is a cross-sectional diagram of a polishing carrier according to a sixth embodiment.

### BEST MODE FOR CARRYING OUT THE INVENTION

### First Embodiment

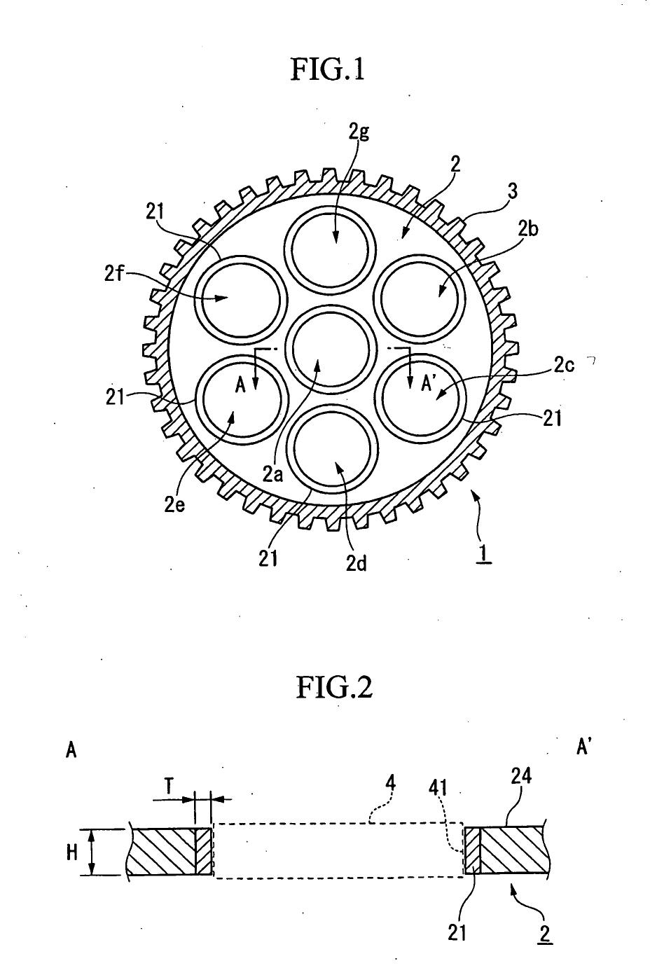

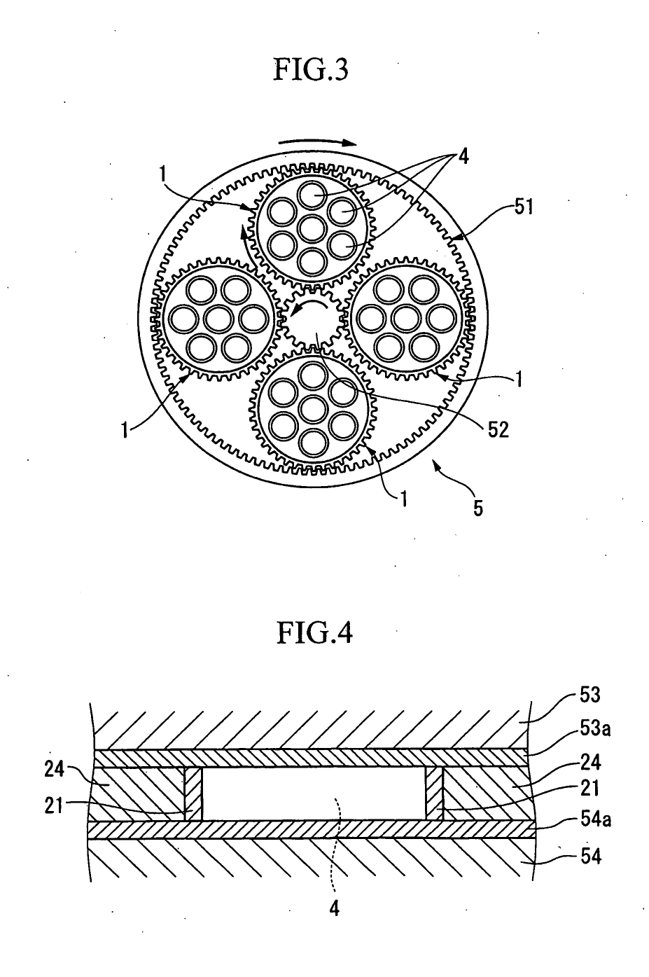

FIG. 1 is a plan view of a polishing carrier according to a first embodiment of the present invention. FIG. 2 is a diagram showing a cross-section through line A-A′ of FIG. 1. FIG. 3 is a diagram showing a state in which polishing carriers are mounted in a polishing device. FIG. 4 is a partial cross-sectional diagram of FIG. 3. Hereunder is a description with reference to the drawings.

In FIG. 1, a polishing carrier 1 comprises a disc-shaped substrate holding section 2, and a gear section 3 fitted onto and fixed to the outer periphery of the substrate holding section. A plurality of substrate holding holes 2a to 2g is formed in the substrate holding section 2. The substrate holding holes 2a to 2g are of a suitable size to hold silicon substrates for magnetic recording media. The size of the silicon substrate is not limited specifically. However, 1 inch (25.4 mmØ) or 0.85 inch (21.6 mmØ) diameter silicon substrates for a magnetic recording medium can be given as examples.

FIG. 2 is a cross-sectional diagram through line A-A′ of FIG. 1, and is an example of a polishing carrier in which the substrate holding section 2 is formed from one layer of a hard material 24, and a cushion 21 of a soft material is bonded and fixed to the internal surface of the substrate holding holes 2a to 2g. The substrate holding section 2 containing the cushions 21 is formed to be slightly thinner than the thickness of the silicon substrate 4.

For the hard material 24, a fiber reinforced epoxy resin may be used, for example, and for the cushion 21, any type selected from epoxy resin, suede, and polypropylene resin can be used, for example, which are softer materials than a polishing pad or the silicon substrate.

Since the hardness (Asker C) of the polishing pad used when polishing or lapping is less than 100, it is preferable to use the abovementioned materials whose hardnesses are less than or equal to 100 Asker C for the cushion 21. For reference, the hardnesses (Asker C) of the materials are epoxy resin: less than or equal to 80; suede: 50 to 80; polypropylene resin: 70 to 110, and the hardness of the silicon substrate is much greater than 110.

By constructing the substrate holding section 2 of the polishing carrier in this manner, the edge face (outer peripheral side face) of the silicon substrate 4 only makes contact with the comparatively soft cushion 21 as shown in FIG. 2, and does not make contact with the epoxy resin layer, which is the hard material 24. As a result, it is possible to effectively prevent the edge face (outer peripheral side face) 41 of the silicon substrate 4 from being scratched during polishing.

The above-described example shows an example in which a fiber reinforced epoxy resin is used as the hard material 24. However, any material that is harder than the cushion 21, and that can achieve sufficient accuracy on the surface of the substrate when polished or lapped, may be used. For example, materials such as glass epoxy (FRP), stainless steel (SUS) and the like can be used.

Furthermore, the thickness of the polishing carrier 1 is adjusted appropriately according to the final thickness of the substrate to be obtained. For example, in the case of a 1 inch silicon substrate, the thickness of the silicon substrate is 0.381±0.010 mm. Therefore it is preferable to make the thickness of the polishing carrier 1 thinner than this, which is approximately 0.3 to 0.35 mm. The height H of the cushion 21 of the polishing carrier 1 which makes contact with the substrate, is less than or equal to the thickness of the polishing carrier 1. Moreover, the thickness T of the cushion 21 may be 0.5 to 1.0 mm.

The gear section 3 as shown in FIG. 1, is for engaging with and being rotated by the sun gear and the internal gear in the polishing device, and is formed from stainless steel, which has good mechanical durability and wear resistance. Its inner peripheral edge face is bonded and fixed to the outer peripheral edge face of the substrate holding section 2.

Next is a summary description of a polishing process, in which the polishing carriers 1 are mounted in the polishing device, and the silicon substrates 4 for magnetic recording media are polished or lapped.

FIG. 3 is a diagram showing a state in which the polishing carriers 1 are mounted in the polishing device.

In the polishing device, the polishing carriers 1 are mounted in a polishing carrier mounting section 5 having an internal gear 51 and a sun gear 52, which are rotated and driven at a predetermined rotational ratio.

When the plurality of polishing carriers 1 is fitted in the polishing carrier mounting section 5, the gear sections 3 of the polishing carriers 1 are engaged with the internal gear 51 and the sun gear 52.

Furthermore, in the polishing device, as shown in FIG. 4, an upper surface plate 53 and a lower surface plate 54 are driven counter-rotationally with the polishing carrier mounting section 5 between them, so that the front and reverse surfaces of the silicon substrates 4 are polished or lapped at the same time by polishing pads 53a and 54a affixed to the upper surface plate and the lower surface plate 54.

When the silicon substrates 4 for magnetic recording media, which are objects to be polished, are mounted in the substrate holding holes 2a to 2g of each of the polishing carriers 1 and start to be polished, the polishing carriers 1 perform planetary motions due to the difference in the revolution speeds of the internal gear 51 and the sun gear 52. At the same time, the upper surface plate 53 and the lower surface plate 54 rotate in opposite directions, and the front and reverse surfaces of the silicon substrates 4 are polished or lapped at the same time.

Normally, substrates for magnetic recording media are finished to a mirror finish via steps of rough polishing, lapping (grit covered), edge face mirror processing, and polishing. Here, the lapping process aims to improve the dimensional accuracy and the form accuracy, and processes the main surfaces of the substrates by a lapping machine. The polishing process aims to improve the smoothness (reduce the surface roughness) of the surfaces, and to reduce the manufacturing distortion. Normally, it comprises a first polishing process in which a hard polisher is used, and a second polishing process (final polishing process) in which a soft polisher is used.

The polishing carriers of the present invention can be used for any of the processes described above. However, by using them after the process for mirror finishing the edge faces, for example for the polishing process after the lapping process, the maximum effect can be demonstrated.

### Second Embodiment

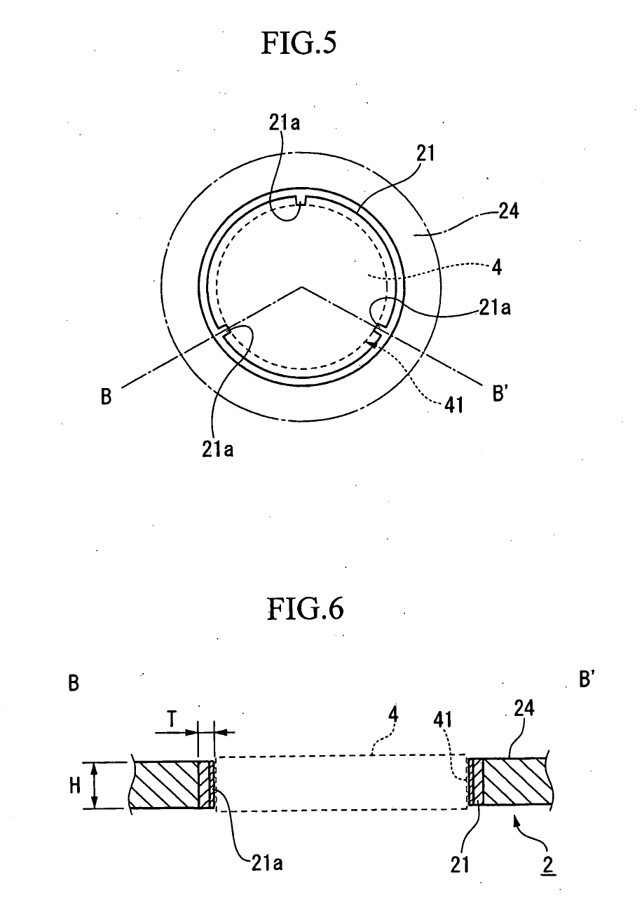

FIG. 5 is a plan view of a polishing carrier according to a second embodiment of the present invention.

The characteristic feature of the polishing carrier according to the second embodiment is that, as shown in FIG. 5, a plurality of protrusions 2a is provided on the cushion 21. FIG. 6 is a diagram showing a cross section through line B-B′ of FIG. 5. As shown in FIG. 5 and FIG. 6, in the present embodiment, since the edge face 41 of a silicon substrate 4 only makes contact with the protrusions 2a of the cushion 21, there is no concern about scratches occurring due to the sliding motion of the edge face 41.

FIG. 5 shows an example of three protrusions 21a. If the number of the protrusions 21a is two, the support is unstable, and if it exceeds seven, the effect of reducing the number of contact points will be lost. Therefore, it is appropriate to form protrusions in between three and six . The protrusions 21a may protrude by approximately 0.5 mm from the surface of the cushion 21.

For the cushion 21, a material whose hardness is less than that of a silicon substrate is used. For example, any type selected from suede, polyamide resin, polypropylene resin, or epoxy resin can be used and, especially, the use of epoxy resin is desirable.

### Third Embodiment

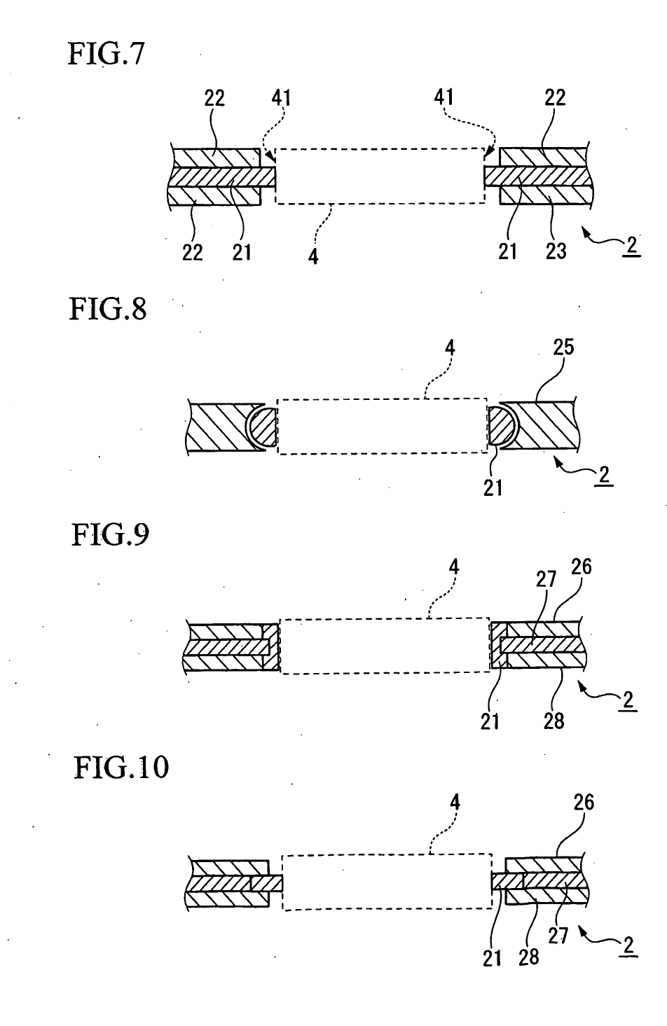

FIG. 7 is a cross-sectional diagram of a polishing carrier according to a third embodiment of the present invention.

The characteristic feature of the polishing carrier according to the third embodiment is that, as shown in FIG. 7, the cushion 21 is sandwiched between an upper side member 22 and a lower side member 23 in a sandwich structure, and fixed by bonding. In this embodiment, an epoxy resin material is used for the cushion 21, and a fiber reinforced epoxy resin, which is a harder material, is used for the upper side member 22 and the lower side member 23.

In this case, open holes that constitute substrate holding holes 2a to 2g are formed in the cushion 21, the upper side member 22, and the lower side member 23. However, the hole diameter of the open holes of the cushion 21 is slightly less than the diameters of the holes formed in the upper side member 22 and the lower side member 23.

Accordingly, the edge face (outer peripheral side face) 41 of the silicon substrate 4 only makes contact with the cushion 21 formed from comparatively soft epoxy resin, and it does not make contact with the hard upper side member 22 and lower side member 23.

For the cushion 21, a material whose hardness is less than that of a silicon substrate is used. For example, any type selected from suede, polyamide resin, polypropylene resin, or epoxy resin can be used and, especially, the use of epoxy resin is desirable.

As a result, scratches are prevented from being produced on the edge face (outer peripheral side face) 41 of the silicon substrate 4 during polishing, effectively.

### Fourth Embodiment

FIG. 8 is a cross-sectional diagram of a polishing carrier according to a fourth embodiment of the present invention.

The characteristic feature of the polishing carrier according to the fourth embodiment is that, as shown in FIG. 8, a substrate holding section 2 is formed from a layer of hard material, the inner peripheral surface of each of the substrate holding holes 2a to 2g is formed in a concave curved surface, and a ring-shaped cushion 21 whose inner peripheral surface is finished to a flat is fitted into the concave curved surface section.

Here also, for the cushion 21, a material whose hardness is less than that of the silicon substrate is used. For example, any type selected from suede, polyamide resin, polypropylene resin, or epoxy resin can be used and, especially, the use of epoxy resin is desirable.

As a result, scratches are effectively prevented from being produced on the edge face (outer peripheral side face) 41 of the silicon substrate 4 during polishing.

### Fifth Embodiment

FIG. 9 is a cross-sectional diagram of a polishing carrier according to a fifth embodiment of the present invention.

The characteristic feature of the polishing carrier according to the fifth embodiment is that, as shown in FIG. 9, a substrate holding section 2 is formed from three layers of an upper side member 26, an intermediate member 27 and a lower side member 28, which are formed from a hard material, stacked and fixed together. The hole diameter of the intermediate member 27 only is formed slightly smaller, so that the intermediate member 27 protrudes toward the inner peripheral surface of the substrate holding holes 2a to 2g. A ring formed from a cushion 21, which has a cavity in its outer periphery, is fitted onto and fixed to this protruding section.

Here also, for the cushion 21, a material whose hardness is less than that of the silicon substrate is used. For example, any type selected from suede, polyamide resin, polypropylene resin, or epoxy resin can be used and, especially, the use of epoxy resin is desirable.

For the intermediate member 27, a material is desirable, which has a higher mechanical strength in the vertical and horizontal directions and provides a high strength gear, and which produces less debris. For example, stainless steel, aramid fiber glass epoxy, or the like, can be used.

As a result, scratches are effectively prevented from being produced on the edge face (outer peripheral side face) 41 of the silicon substrate 4 during polishing.

### Sixth Embodiment

FIG. 10 is a cross-sectional diagram of a polishing carrier according to a sixth embodiment of the present invention.

The characteristic feature of the polishing carrier according to the sixth embodiment is that, as shown in FIG. 10, a substrate holding section 2 is formed from an upper side member 26, an intermediate member 27 and a lower side member 28, which are formed from a hard material, stacked and fixed together. The hole diameter of the intermediate member 27 only is formed slightly smaller, so that cavities are formed in the inner peripheral surfaces of the substrate holding holes 2a to 2g. Rings formed from the cushions 21 are fitted into and fixed to the cavities, and the rings protrude toward the internal circumference surfaces of the substrate holding holes 2a to 2g.

Here also, for the cushion 21, a material whose hardness is less than that of the silicon substrate is used. For example, any type selected from suede, polyamide resin, polypropylene resin, or epoxy resin can be used and, especially, the use of epoxy resin is desirable.

For the intermediate member 27, a material is desirable, which has high mechanical strength in the vertical and horizontal directions and which provides high strength gear, and which produces less debris. For example, stainless steel, aramid fiber glass epoxy, or the like, can be used.

As a result, scratches are effectively prevented from being produced on the edge face (outer peripheral side face) 41 of the silicon substrate 4 during polishing.

The polishing carrier of the present invention can be used for a lapping process or a polishing process. The following is a detailed description of polishing.

When polishing (either a first polishing process, or a final polishing process) is performed, in a state in which the gear section 3 formed in the outer periphery section of the polishing carrier I is engaged with the sun gear 52 and the internal gear 51 of the polishing carrier mounting section 5, the polishing carrier 1 is mounted onto the lower surface plate 54 to which the polishing pad 54a of the polishing carrier mounting section 5 is affixed. Next, silicon substrates 4 for magnetic recording media, which are objects to be polished, are placed into the substrate holding holes 2a to 2g, and held in place.

Next, the silicon substrates 4 are sandwiched between the lower surface plate 54 on which polishing pad 54a is affixed, and the upper surface plate 53 on which the polishing pad 53a is affixed, and while a polishing liquid containing abrasive grains formed from colloidal silica is supplied, the lower surface plate 54 and the upper surface plate 53 are rotated in opposite directions. As a result, due to the difference in the rotation speeds of the sun gear 52 and the internal gear 51, the polishing carrier 1 rotates while rotating on its own axis, and the two surfaces of the silicon substrates 4 are polished at the same time.

The silicon substrates 4 rotate in the substrate holding holes 2a to 2g during the polishing process, and they rub against the inner peripheral sections of the substrate holding holes 2a to 2g. However, since the cushion 21 holding the silicon substrate 4 is a soft material, the edge faces of the silicon substrates 4 do not become scratched.

For the polishing pads 53 and 54, a soft polisher whose material is suede or velour, and a hard polisher such as hard velour, urethane foam, pitch impregnated suede and the like, are offered as examples.

Hereunder is a detailed description of a manufacturing process using a one inch (25.4 mm) diameter silicon substrate for a magnetic recording medium as an example.

### (1) First Lapping Process (First Grit Covered Process)

First, a single crystal silicon ingot, which is produced by the Czochralski method, is sliced into slices approximately 1 mm thick to produce silicon substrates.

Next, lapping is performed on the silicon substrates. This lapping process aims to improve the dimensional accuracy and the form accuracy. The lapping process is performed using a lapping device, aluminum grit of grain size #400 is used as a polishing medium, the load L is set to approximately 100 g/cm², and by rotating the sun gear and the internal gear, the two surfaces of the silicon substrates stored in the carriers are lapped to a profile irregularity of 0 to 1 μm, and a surface roughness (Rmax) (measured to JISB0601) of approximately 6 μm.

Next, using a cylindrical grinder, a hole of 5.8 mm diameter is made in the center of each silicon substrate, and a predetermined chamfer is formed on the outer peripheral edge face and the inner peripheral edge face. The surface roughness of the inner and outer peripheral edge faces of the silicon substrate at this time is approximately 14 μm Rmax.

### (2) Edge Face Polishing Process

Next, by brushing using a colloidal silica grit of approximately 100 nm average grain size, the edge face parts (angular part, side face and chamfered part) of the substrate are polished while the silicon substrate is rotated, the angular part is formed to a curved surface of a radius of 0.2 to 10 mm, and the surface roughness is taken to approximately 1 μm Rmax, and 0.3 μm Ra. The surface of the silicon substrate whose edge faces have been polished is flushed using water.

### (3) Second Lapping Process (Second Grit Covered Process)

Next, a lapping device is used, a polishing carrier whose cushion is formed from epoxy resin is used, aluminum grit of grit size approximately #1000 (grain size approximately 3 μm) is used, the load L is set to approximately 100 g/cm², and by rotating the sun gear and the internal gear, lapping is performed, taking the surface roughness (Rmax) of the two surfaces of the silicon substrate to approximately 2 μm. The silicon substrates that have finished the second lapping process are dipped in washing tanks of neutral detergent and water in sequence to wash them.

### (4) First Polishing Process (Primary Polishing Process)

A first polishing process aims to remove the scratches and distortion remaining after the lapping process, and it is performed using a polishing device. To be specific, a hard polisher (cerium pad MHC15: made by the SpeedFam company) is used as a polishing pad (polishing cloth), a polishing carrier formed from epoxy resin (hardness 80 (Asker C)) is used for a cushion, and polishing is performed where the polishing conditions are polishing medium: colloidal silica of 80 nm average grain size+water, load: 100 g/cm², lower surface plate revolution speed: 40 rpm, upper surface plate revolution speed: 35 rpm, sun gear revolution speed: 14 rpm, internal gear revolution speed: 29 rpm.

The silicon substrates that have completed the first polishing process as described above are soaked in washing tanks of neutral detergent, pure water, pure water in sequence to wash them.

### (5) Second Polishing Process (Final Polishing Process)

Next, using the polishing device used in the first polishing process, the polishing pad is changed to a soft polisher from a hard polisher, and a polishing carrier formed from epoxy resin is used for the cushion to perform the second polishing process. The polishing conditions may be the same as those in the first polishing process, except that the polishing medium is colloidal silica (average grain size: 40 nm), the load is 100g/cm², and the amount removed is 1 μm. The silicon substrates that have completed the second polishing process are immersed in washing tanks of neutral detergent, neutral detergent, pure water, pure water, IPA (isopropyl alcohol), and IPA (steam drying) in sequence to wash them. Here, it is desirable to apply ultrasonic waves to each of the washing tanks.

Silicon substrates for magnetic recording media are obtained through the processes described above.

### EXAMPLE

The silicon substrates treated in the polishing processes using the polishing carrier used in the first embodiment, and the polishing carrier used in the second embodiment, were subjected to vibration similar to that which they can be expected to receive when they are stored and moved in cassettes for transport, and the condition of the damage occurring on the substrate edge faces, and the appearance of debris produced, were examined.

The substrate holding sections used for the polishing carriers were formed from fiber reinforced epoxy resin, and the cushions were formed from epoxy resin. Furthermore, silicon substrates of one inch (25.4 mm) diameter were used.

The condition of the damage occurring on the substrate edge faces was examined by observing the substrate edge faces using an optical microscope. Furthermore, a debris production test was performed by the following procedure using the cassettes for transport.

(1) The silicon substrates were inserted in the cassette, then the top cover was installed for packing.

(2) To simulate transport, the silicon substrates were moved ten times towards both the bottom and top of the cassette.

(3) To simulate loading and unloading of the cassette, the silicon substrates were inserted into and removed from the grooves of the cassette.

After the above-described processes (1), (2) and (3) were completed, the number of polycarbonate particles, being the cassette material, produced on the substrate outer peripheral sections was measured using an optical microscope. Measurements were performed by observation of a sample of 10 substrates, and a comparison was performed using the value of the number of particles counted divided by the number (10) of the substrates. The results are shown in Table 1.

For comparison, a similar test was performed using a polishing carrier that had its substrate holding holes formed from fiber reinforced epoxy resin without cushions, and a polishing carrier that had its substrate holding holes formed from fiber reinforced epoxy resin with three protrusions. The results are listed together in Table 1.

TABLE 1

| | | | Scratches | |
|---|---|---|---|---|
| | | | produced on | Proportion |
| | Num- | | substrate edge | of particle |
| | ber | Polishing carrier | face | generation |
| Examples | 1 | Epoxy resin cushion | None | 0.5 |
| | 2 | Epoxy resin cushion | None | 0.4 |
| | | with three notches | | |
| Comparative | 3 | No cushion | Many scratches | 8.2 |
| examples | 4 | No cushion, | A few Scratches | 4.7 |
| | | three notches | | |

The results in Table 1 show that in the case where the polishing carrier of the present invention was used for the process, there were no scratches produced on the substrate edge faces, and the number of particles produced was also considerably reduced.

1. A polishing carrier that has a substrate holding hole that holds a silicon substrate for a magnetic recording medium, wherein a part of the internal circumference of said substrate holding hole that makes contact with said silicon substrate is formed from a cushion whose hardness is less than that of the silicon substrate.

2. A polishing carrier according to claim 1, wherein said cushion is epoxy resin.

3. A polishing carrier according to claim 1, wherein said cushion is any material selected from the group consisting of suede, polyamide resin, and polypropylene resin.

4. A polishing carrier according to claim 1, wherein a thickness of said cushion is less than or equal to 1 mm.

5. A polishing carrier according to claim 1, wherein a plurality of protrusions which make contact with the silicon substrate, are provided on the internal circumference surface of said cushion.

6. A polishing carrier according to claim 5, wherein the number of said protrusions is between three and six.

7. A method of manufacturing a silicon substrate for a magnetic recording medium, wherein a silicon substrate for a magnetic recording medium is polished using a polishing carrier according to claim 1.

8. A method of manufacturing a silicon substrate for a magnetic recording medium according to claim 7, wherein said silicon substrate for a magnetic recording medium is polished by rotating the substrate by engagement with a sun gear and an internal gear.

9. A silicon substrate for a magnetic recording medium, which is manufactured using a method of manufacturing a silicon substrate for a magnetic recording medium according to claim 7.
